(19) United States
(12) Patent Application Publication
(10) Pub. No.: US 2013/0088982 A1
(43) Pub. Date: Apr. 11, 2013

(54) METHOD AND APPARATUS FOR CONTROLLING COVERAGE OF WIRELESS TRANSCEIVER

(71) Applicant: Samsung Electronics Co., Ltd., Gyeonggi-do (KR)

(72) Inventors: Hee-chul Jeon, Gyeonggi-do (KR); Yong-gook Park, Gyeonggi-do (KR); Ho-jun Lee, Gyeonggi-do (KR)

(73) Assignee: Samsung Electronics Co., Ltd., Gyeonggi-do (KR)

(21) Appl. No.: 13/646,035

(22) Filed: Oct. 5, 2012

(30) Foreign Application Priority Data
Oct. 5, 2011 (KR) 10-2011-0101436

(51) Int. Cl. H04W 64/00; H04W 24/08

(52) U.S. Cl. 370/252; 370/328

(57) ABSTRACT

A method of controlling coverage of a wireless transceiver, including receiving information about the wireless transceiver from an external device, and changing a coverage value of the wireless transceiver, which has been set in advance, based on the received information about the wireless transceiver.

### PRIORITY

This application claims priority to Korean Patent Application No. 10-2011-0101436, filed on Oct. 5, 2011, in the Korean Intellectual Property Office, the contents of which are incorporated herein by reference.

### BACKGROUND OF THE INVENTION

1. Field of the Invention

The present invention relates generally to a method and apparatus for controlling coverage of a wireless transceiver, and more particularly, to a method and apparatus for controlling coverage of a wireless transceiver based on the strength of a signal transmitted by the wireless transceiver.

2. Description of the Related Art

A wireless Local Area Network (LAN), which is typically referred to as Wi-Fi, is used within a predetermined distance from installed access points, or wireless transceivers, to provide a wireless communication service.

In view of the worldwide increase in sales of mobile devices that handle large amounts of traffic, such as smartphones, tablet Personal Computers (PCs), and mobile PCs, shipments of Wi-Fi devices significantly increase every year. Following this trend is the increased installation of wireless access points or wireless transceivers for transmitting a Wi-Fi wireless signal, such as a beacon. However, there is a need in the art to control coverage of beacons to accurately define a zone where a Wi-Fi local service is provided.

### SUMMARY OF THE INVENTION

The present invention provides a method and apparatus for controlling coverage of a wireless transceiver, wherein the coverage is accurately controlled by an external apparatus, such as a server, and for updating the coverage based on the strength of a signal transmitted by the wireless transceiver.

According to an aspect of the present invention, there is provided a method of controlling coverage of a wireless transceiver, including receiving information about the wireless transceiver from an external device, and changing a coverage value of the wireless transceiver that has been set in advance, based on the received information about the wireless transceiver.

According to another aspect of the present invention, there is provided an apparatus for controlling coverage of a wireless transceiver, including a communication unit that receives information about the wireless transceiver from an external device, and a control unit that changes a coverage value of the wireless transceiver based on the received information about the wireless transceiver.

### BRIEF DESCRIPTION OF THE DRAWINGS

The above and other features and advantages of the present invention will become more apparent by describing in detail embodiments thereof with reference to the attached drawings in which:

FIG. 1 illustrates a location-based service supply system according to an embodiment of the present invention;

FIG. 2 illustrates a method of providing a near field service by a wireless transceiver, according to an embodiment of the present invention;

FIG. 3 illustrates a critical received signal strength table according to an embodiment of the present invention;

FIG. 4 illustrates a method of controlling coverage of a wireless transceiver, according to an embodiment of the present invention;

FIG. 5 illustrates a method of changing coverage of a wireless transceiver, according to an embodiment of the present invention;

FIGS. 6A and 6B illustrate changed coverage of a wireless transceiver, according to embodiments of the present invention; and

FIG. 7 illustrates a coverage change device of a wireless transceiver, according to an embodiment of the present invention.

### DETAILED DESCRIPTION OF EMBODIMENTS OF THE INVENTION

Embodiments of the present invention will now be described in detail with reference to the attached drawings. Those of ordinary skill in the art will recognize that various changes and modifications of the embodiments described herein can be made without departing from the scope and spirit of the invention. Also, descriptions of well-known functions and constructions are omitted for the sake of clarity and conciseness.

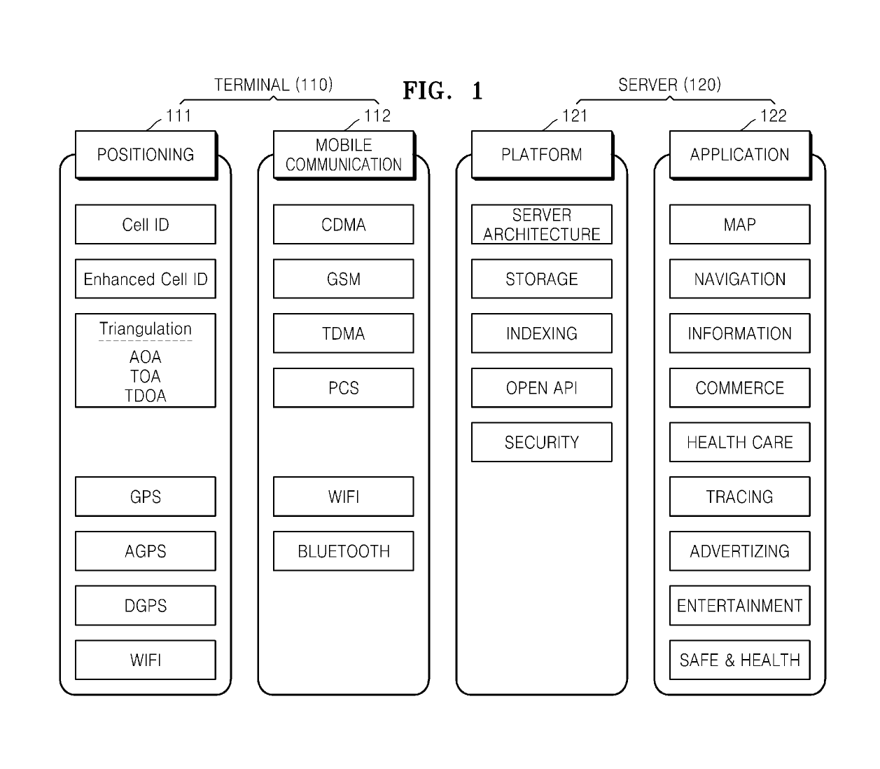

FIG. 1 illustrates a location-based service supply system according to an embodiment of the present invention.

The location-based service supply system includes a terminal 110 and a server 120. The terminal 110 includes a positioning 111 module and a mobile communication 112 module, and the server 120 includes a platform 121 and an application 122. In the current embodiment, the structure of each of these components is just an example, and the present invention is not limited thereto.

The positioning 111 module performs location verification of the terminal 110 and uses triangulation, such as cell ID, enhanced cell ID, Angle of Arrival (AoA), Time of Arrival (ToA), Time Difference of Arrival (TDoA), Global Positioning System (GPS), Assisted GPS (AGPS), Differential GPS (DGPS), or WiFi.

The mobile communication 112 module performs communication between the terminal 110 and the server 120. Examples of a mobile communication-related technology are Code Division Multiple Access (CDMA), Global System for Mobile communications (GSM), Time Division Multiple Access (TDMA), and Personal Communication Service (PCS). Examples of a near field communication related technology are WiFi and Bluetooth®.

The platform 121 may include server architecture, storage, indexing, open Application Programming Interface (API), and security. The server architecture technology refers to a location-based processing technology that corresponds to a location-based function, such as obtaining of a location from a location-obtaining server and responding to a location information request of the terminal side 110 (client), managing of location information and processing of location information regarding an individual or a group, and tracing of a movement path.

The storage technology is for storing and managing information with a large capacity. The indexing technology is for organizing location information or information regarding the location information in an optimized form and constituting the information for ease of search. The open API technology enables websites to interact with each other by providing location information and information regarding the location information. The security technology is for controlling user access, such as user profile management, authorization, and security.

The application 122 is for finally providing a location-based service to the terminal side 110. Examples of the application 122 include map, navigation, information, commerce, health care, tracing, advertising, entertainment, health and safety.

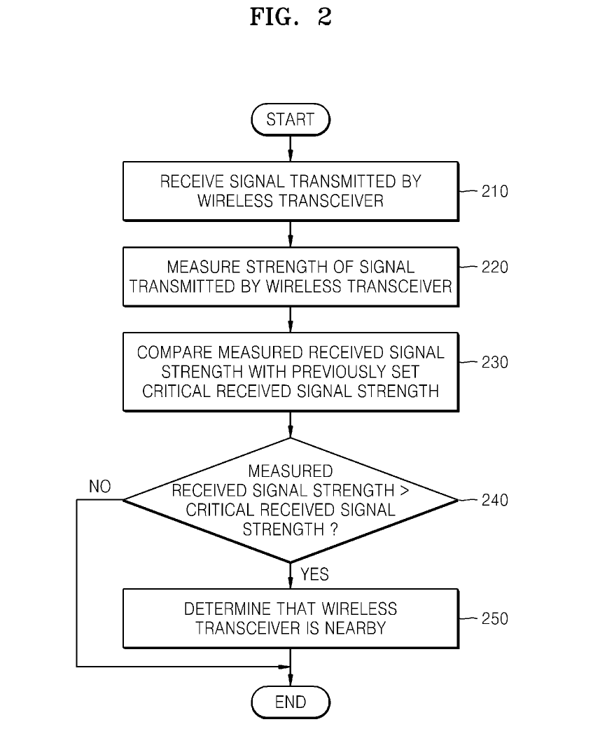

FIG. 2 illustrates a method of providing a near field service by a wireless transceiver, according to an embodiment of the present invention.

Referring to FIG. 2, in step 210, a terminal receives signals transmitted by at least one wireless transceiver, where wireless transceivers broadcast the same transmission signal strength. The wireless transceiver may be a beacon or an AP. The transmission signals of the wireless transceiver may include MAC address information as unique information, a Service Set Identifier (SSID) or a Basic Service Set Identifier (BSSID).

In step 220, the terminal measures the strength of a signal transmitted by a wireless transceiver. When the terminal receives a signal transmitted by the wireless transceiver, the terminal detects a Received Signal Strength Indication (RSSI), which is the strength of the signal received.

In step 230, the terminal compares the measured received signal strength with a critical received signal strength that has been stored in advance. The critical received signal strength may have been already stored by using an external apparatus, such as an external server. The critical received signal strength refers to a critical value that is used as a reference that is considered in determining that the terminal is near the wireless transceiver. Identifying a wireless transceiver that has transmitted the signal received as a reference for comparison may be executed based on a MAC address as unique information of the wireless transceiver or BSSID.

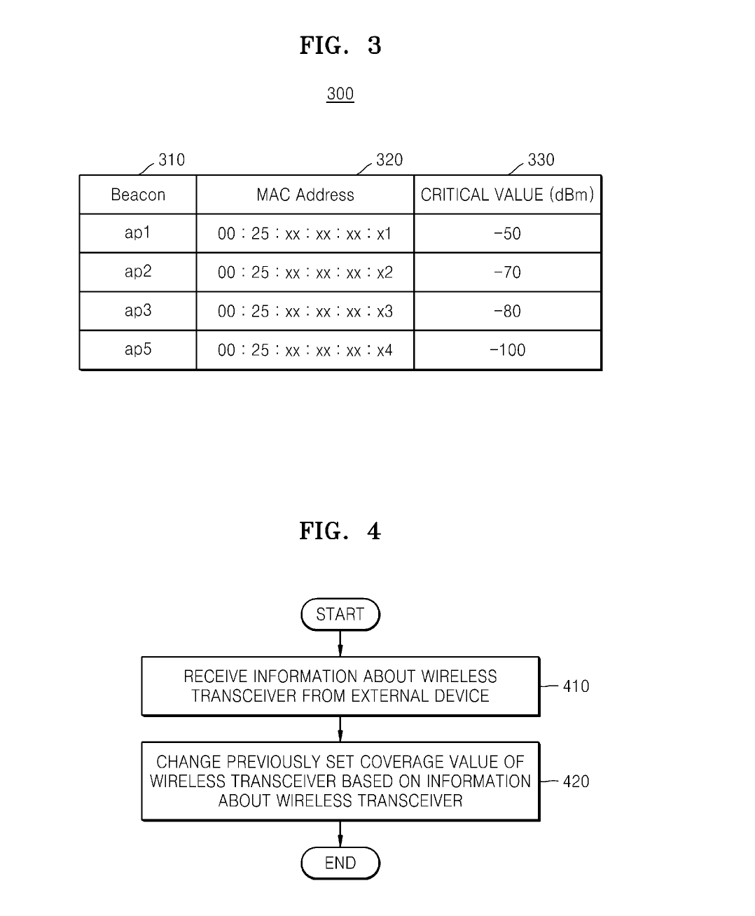

The remainder of the description of FIG. 2 will be given after the description of FIG. 3, which illustrates a critical received signal strength table 300 according to an embodiment of the present invention.

Referring to FIG. 3, the critical received signal strength table 300 includes beacon identification information 310, a MAC address 320, and a critical received signal strength 330. A decibel miliwatt (dBm) is a unit of the critical received signal strength 330. For example, when a terminal receives a signal transmitted by a beacon that has a MAC address of 00:25:xx:xx:xx:x1, the terminal detects a received signal strength of the transmission signal, extracts the MAC address 00:25:xx:xx:xx:x1, and compares a critical received signal strength of −50 dBm with the detected signal received signal strength.

Returning to the description of FIG. 2, in step 240, the terminal determines whether the measured received signal strength is equal to or greater than the critical received signal strength, and if the measured received signal strength is equal to or greater than the critical received signal strength, step 250 is performed. For example, referring to FIG. 3, if a measured received signal strength of a signal transmitted by a beacon that has a MAC address of 00:25:xx:xx:xx:x1 is −40 dBm, the received signal strength is greater than the critical signal strength that is −50 dBm.

In step 250 of FIG. 2, when the measured received signal strength is equal to or greater than the critical received signal strength, the terminal determines that the wireless transceiver is nearby. For example, referring to FIG. 3, if a measured received signal strength of a transmission signal from a beacon that has a MAC address of 00:25:xx:xx:xx:x1 is −40 dBm, the received signal strength is greater than the critical signal strength that is −50 dBm and thus, the terminal determines that ap1 is nearby. Also, if the measured received signal strength is less than the critical received signal strength, the terminal determines that a wireless transceiver that transmits the signal received is not nearby.

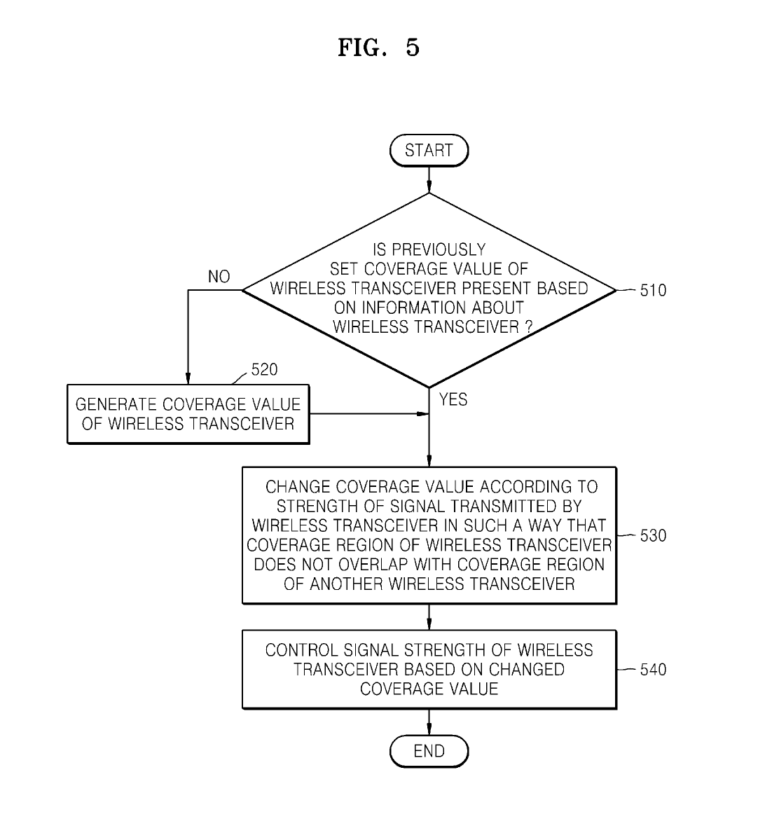

FIG. 4 illustrates a method of controlling coverage of a wireless transceiver, according to an embodiment of the present invention.

Referring to FIG. 4, in step 410, a coverage control apparatus receives information about a wireless transceiver from an external device, which receives a signal that is transmitted by a wireless transceiver, such as a beacon or an AP. A transmission signal of the wireless transceiver may include MAC address information as unique information, and an SSID or a BSSID. Thereafter, the external device measures a received signal strength of the transmission signal of the wireless transceiver. When the external device receives a transmission signal from the wireless transceiver, the external device detects an RSSI of the received signal, and a location of the wireless transceiver.

For example, the external device may detect a location of the wireless transceiver by using GPS information, or by using a wireless transceiver that is located near the external device. Thereafter, the external device transmits unique information of the wireless transceiver included in the signals transmitted by the wireless transceiver as information about the wireless transceiver and information about the detection signal strength to the coverage control apparatus. If the coverage control apparatus does not have location information about the external device, the external device may transmit the location information about the external device together with information about the wireless transceiver to the coverage control apparatus.

In step 420, the coverage control apparatus may change a coverage value of the wireless transceiver that has been stored in advance, based on the received information about the wireless transceiver. The coverage value is of a distance within which a signal transmitted by the wireless transceiver has access to the external device. The coverage control apparatus changes the coverage value of the wireless transceiver based on the received unique information about the wireless transceiver and the signal strength measured by the external device. If the coverage control apparatus does not have the location information of the external device, the coverage control apparatus changes the coverage value of the wireless transceiver based on the unique information of the wireless transceiver, the signal strength measured by the external device, and the location information of the external device.

The coverage control apparatus may change a coverage region by changing a coverage value according to the signal strength measured by the external device at a location where the external device is placed. For example, if a received signal strength of the external device distanced from the wireless transceiver by 50 meters is −50 dBm and a reference signal strength, which has been set in advance, is −60 dBm, the signal strength of the wireless transceiver is stronger than the reference signal strength. Thus, the coverage region is wider than a reference coverage region. Accordingly, the coverage value is changed such that the previously set reference coverage region is widened. A coverage value corresponding to a reference coverage region is previously determined.

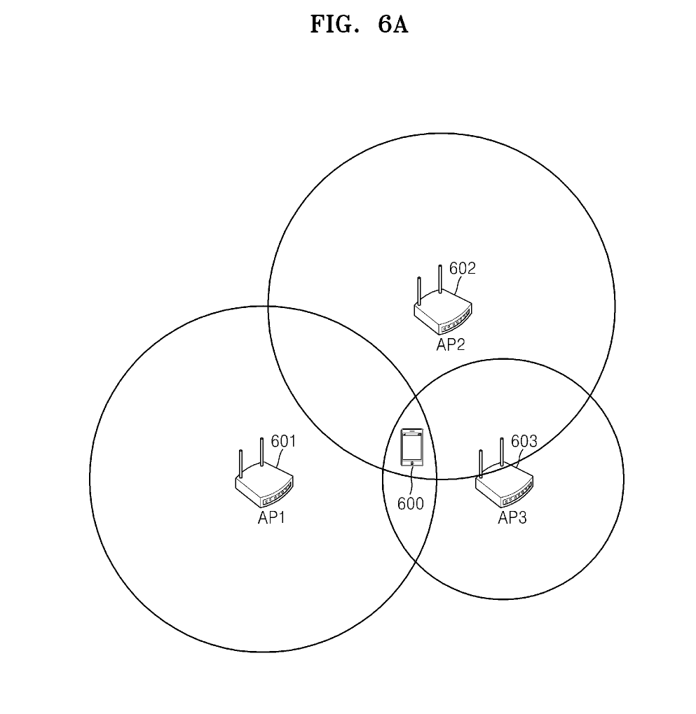

FIG. 5 illustrates a method of changing coverage of a wireless transceiver, according to an embodiment of the present invention.

Referring to FIG. 5, in step 510, a coverage control apparatus determines, based on received information about the wireless transceiver, whether a coverage value of a wireless transceiver exists. That is, the coverage control apparatus determines whether a coverage value of the wireless transceiver corresponding to unique information about the wireless transceiver exists. When the coverage value exists, step 530 is performed, and when the coverage value does not exist, step 520 is performed.

In step 520, if the coverage value of the wireless transceiver does not exist, the coverage control apparatus determines a coverage region according to measured signal strength and generates a corresponding coverage value. Then, step 530 is performed.

In step 530, the coverage control apparatus changes the coverage value according to the strength of a signal transmitted by the wireless transceiver in such a manner that a coverage region of the wireless transceiver does not overlap with a coverage region of another wireless transceiver. The coverage control apparatus may compare the strength of a signal transmitted by the wireless transceiver that has been measured by the external device with a previously set reference signal strength and may change the coverage value correspondingly.

For example, when the strength of the signal transmitted by the wireless transceiver, which has been measured at a location where the external device is currently positioned, is smaller than the previously set reference signal strength, a coverage region is substantially smaller than a previously set reference coverage region. Thus, the reference coverage region needs to be reduced. That is, the coverage control apparatus changes a coverage region according to the signal strength difference and changes a coverage value according to the changed coverage region. The coverage control apparatus changes a coverage value in such a manner that coverage regions of surrounding wireless transceivers do not overlap, to allow an external device to receive a signal transmitted by an appropriate wireless transceiver. According to policy, a coverage value may be changed such that coverage regions of some wireless transceivers overlap with each other and other wireless transceivers do not overlap with each other.

If the coverage control apparatus generates a coverage value due to absence of the coverage value of the wireless transceiver, it is possible that the generated coverage region may overlap with a coverage region of another wireless transceiver. In this case, the coverage control apparatus may reset the coverage region to prevent overlapping in the same manner as described above, and may change a coverage value in correspondence to the reset coverage region.

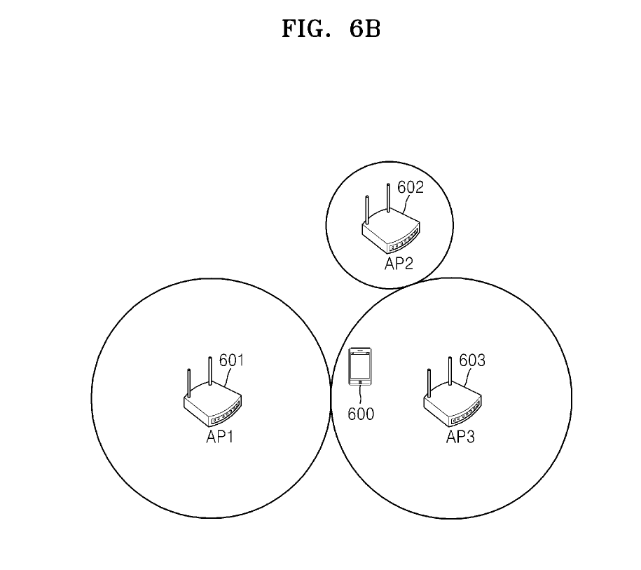

The remainder of the description of FIG. 5 will be given after the description of FIGS. 6A and 6B, which illustrate changed coverage of a wireless transceiver, according to embodiments of the present invention.

FIG. 6A illustrates coverage regions according to strengths of signals that are transmitted by wireless transceivers AP1 601, AP2 602, and AP3 603 and are received by a terminal 600. In FIG. 6A, the terminal 600 is located in an overlapping region of the coverage regions.

In FIG. 6B, the coverage control apparatus changes a coverage value such that the coverage regions of the wireless transceivers AP1 601, AP2 602, and AP3 603 do not overlap with each other.

Returning to FIG. 5, in step 540, the coverage control apparatus controls signal strengths of the wireless transceivers AP1 601, AP2 602, and AP3 603 based on the changed coverage value. Each of the wireless transceivers AP1 601, AP2 602, and AP3 603 includes an interface capable of controlling a signal strength. The coverage control apparatus may transmit information about the changed coverage value to the wireless transceivers AP1 601, AP2 602, and AP3 603 through an external device, or directly transmit the information to the wireless transceivers AP1 601, AP2 602, and AP3 603. Thereafter, each of the wireless transceivers AP1 601, AP2 602, and AP3 603 controls a transmission signal strength in correspondence to the changed coverage value.

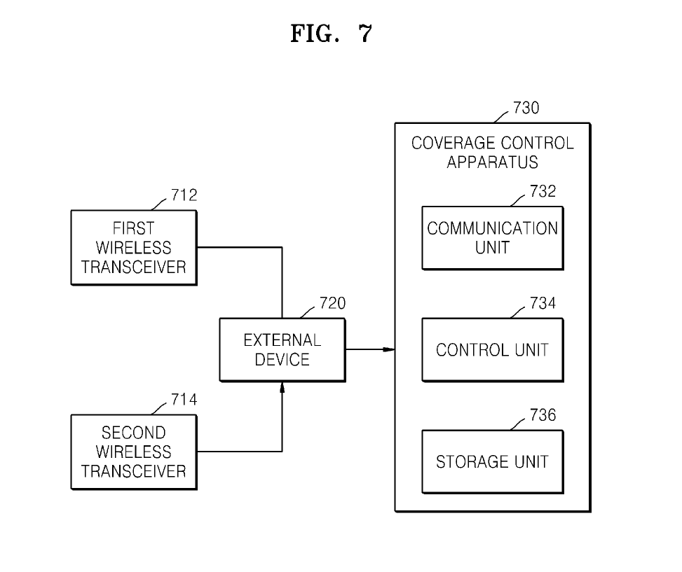

FIG. 7 illustrates a coverage change device of a wireless transceiver, according to an embodiment of the present invention.

Hereinafter, an embodiment regarding a terminal to which a near field service is provided by wireless transceivers 712 and 714 will be described.

Referring to FIG. 7, the terminal is an external device 720. The external device 720 receives signals transmitted by the wireless transceivers 712 and 714, which broadcast transmission signals having the same strength. The wireless transceivers 712 and 714 may each be a beacon or an AP. The transmission signals of the wireless transceivers 712 and 714 may include MAC address information as unique information of the wireless transceivers 712 and 714, and an SSID or a BSSID.

The external device 720 measures strengths of the signals transmitted by the wireless transceivers 712 and 714. When the external device 720 receives the signals transmitted by the wireless transceivers 712 and 714, the external device 720 detects an RSSI of a received transmission signal. Thereafter, the external device 720 compares the measured received signal strength and a previously stored critical received signal strength. The critical received signal strength may have been already stored by using an external apparatus, such as an external server. The critical received signal strength refers to a critical value that is used as a reference that is considered in determining whether the external device 720 is near the wireless transceivers 712 and 714. Identifying the wireless transceivers 712 and 714 that have transmitted the signals received as a reference for comparison may be executed based on a MAC address as unique information of the wireless transceiver or BSSID.

The external device 720 determines that the measured received signal strength is equal to or greater than the critical received signal strength, and in this case, the external device 720 determines that the wireless transceivers 712 and 714 are nearby. Also, when the measured received signal strength is less than the critical received signal strength, the external device 720 determines that the wireless transceivers 712 and 714 that have transmitted the signals are not nearby.

Hereinafter, a method of controlling coverage of the wireless transceivers 712 and 714 by a coverage control apparatus 730 will now be described in detail.

A communication unit 732 receives information related to the wireless transceivers 712 and 714 from the external device 720, which receives signals transmitted by the wireless transceivers 712 and 714, which are a beacon or an AP. The transmission signals of the wireless transceivers 712 and 714 may include MAC address information as unique information of the wireless transceivers 712 and 714, and an SSID or a BSSID. Thereafter, the external device 720 measures strengths of the signals transmitted by the wireless transceivers 712 and 714.

When the external device 720 receives the signals transmitted by the wireless transceivers 712 and 714, the external device 720 detects an RSSI of a received transmission signal, as well as its' location, such as by using GPS information or near field wireless transceivers 712 and 714. The location detection method of the external device 720 may not be limited. Thereafter, the external device 720 may transmit unique information of the wireless transceivers 712 and 714 included in signals transmitted by the wireless transceivers 712 and 714 as information related to the wireless transceivers 712 and 714 and information about the detection signal strength to the coverage control apparatus 730. If the coverage control apparatus 730 does not have the location information of the external device 720, the external device 720 may transport the location information of the external device 720 together with the information related to the wireless transceivers 712 and 714 to the coverage control apparatus 730.

A control unit 734 changes a coverage value previously set for the wireless transceivers 712 and 714 based on the received information about the wireless transceivers 712 and 714. The coverage value is a distance within which a signal transmitted by the wireless transceivers 712 and 714 has access to the external device 720. The control unit 734 changes coverage values of the transceivers 712 and 714 based on the received unique information about the wireless transceivers 712 and 714 and the signal strength measured by the external device 720. If a storage unit 736 does not have location information about the external device 720, the control unit 734 changes coverage values of the transceivers 712 and 714 based on the unique information about the wireless transceivers 712 and 714, the signal strength measured by the external device 720, and the location information of the external device 720. The control unit 734 may change a coverage region by changing a coverage value according to a signal strength that is measured by the external device 720 where the external device 720 is located.

For example, if received signal strengths of the external device at a distance of 50 meters from the wireless transceivers 712 and 714 is −50 dBm and a reference signal strength, which has been set in advance, is −60 dBm, the signal strengths of the wireless transceivers 712 and 714 are stronger than the reference signal strength. Thus, the coverage regions are wider than a reference coverage region. Accordingly, the coverage value is widened. A coverage value corresponding to a reference coverage region is previously determined and stored in the storage unit 736. The coverage value change is described in detail with reference to FIG. 5. A detailed method of changing coverage of the wireless transceivers 712 and 714, performed by the control unit 734, will now be described in detail.

The control unit 734, based on information related to the received information about the wireless transceivers 712 and 714, determines whether coverage values corresponding to the wireless transceivers 712 and 714 are present. That is, the control unit 734 determines that coverage values of the wireless transceivers 712 and 714 corresponding to unique information about the wireless transceivers 712 and 714 are present in the storage unit 736. If the coverage values of the wireless transceivers 712 and 714 are not present in the storage unit 736, the control unit 734 determines a coverage region according to a measured signal strength and generates a corresponding coverage value and stores the coverage value in the storage unit 736.

The control unit 734 changes a coverage value according to strengths of signals transmitted by the wireless transceivers 712 and 714 such that coverage regions of the wireless transceivers 712 and 714 do not overlap with coverage regions of other wireless transceivers. The control unit 734 compares the measured signal strength of the wireless transceivers 712 and 714 with a previously set reference signal strength and changes a coverage value in correspondence to a result of the comparison. For example, if the received signal strengths of transmission signals of the wireless transceivers 712 and 714, which are measured by the external device 720 where the external device 720 is currently located, are less than a previously set reference signal strength, the coverage regions are substantially smaller than a set reference coverage region. Thus, the control unit 734 needs to decrease the size of the reference coverage region.

That is, the control unit 734 changes a coverage region according to a signal strength difference and changes a coverage value according to the changed coverage region and stores the coverage value in the storage unit 736, such that coverage regions of the wireless transceivers 712 and 714 do not overlap with each other. This allows the external device 720 to receive signals transmitted by an appropriate wireless transceiver. The control unit 734 changes a coverage value such that coverage regions of the wireless transceivers 712 and 714 overlap with each other and other wireless transceivers do not overlap each other, based on a policy. If the control unit 734 generates a coverage value due to the absence of coverage values of the wireless transceivers 712 and 714, it is possible that the generated coverage region may overlap with a coverage region of another wireless transceiver. In this case, the control unit 734 may reset the coverage region to prevent the overlapping in the same manner as described above and may change a coverage value in correspondence to the reset coverage region.

The control unit 734 controls signal strengths of the wireless transceivers 712 and 714 based on the changed coverage value. Each of the wireless transceivers 712 and 714 includes an interface capable of controlling a signal strength. The control unit 734 may transmit information about the changed coverage value to the wireless transceivers 712 and 714 through the external device 720, or may directly transmit the information to the wireless transceivers 712 and 714. Thereafter, each of the wireless transceivers 712 and 714 controls a transmission signal strength in correspondence to the changed coverage value.

The method of controlling coverage of a wireless transceiver described above may be embodied as a computer-readable code on a non-transitory computer-readable recording medium, which may be any type of recording device storing data that is readable by a computer. Examples of the recording medium include Read-Only Memory (ROM), Random Access Memory (RAM), CD-ROMs, magnetic tapes, floppy disks, and optical data storage devices. The computer-readable recording medium can also be distributed over a network of coupled computer systems so that the computer-readable code is stored and executed in a decentralized fashion. Function programs, code, and code segments for implementing the service method may be easily derived by programmers of ordinary skill in the art.

While the present invention has been particularly shown and described with reference to embodiments thereof, it will be understood by those of ordinary skill in the art that various changes in form and details may be made therein without departing from the spirit and scope of the present invention as defined by the following claims. Accordingly, the disclosed embodiments should be considered in an illustrative sense rather than in a limiting sense. The scope of the present invention is defined not by the detailed description of the present invention but by the appended claims, and all differences within the scope will be construed as being included in the present invention.

What is claimed is:

1. A method of controlling coverage of a wireless transceiver, the method comprising:
receiving information about the wireless transceiver from an external device; and
changing a preset coverage value of the wireless transceiver based on the received information about the wireless transceiver.

2. The method of claim 1, wherein the information about the wireless transceiver comprises unique information of the wireless transceiver and signal strength information about the wireless transceiver which is detected by the external device.

3. The method of claim 2, wherein the information about the wireless transceiver further comprises location information about the external device.

4. The method of claim 3, wherein the location information about the external device is Global Positioning System (GPS) information about the external device.

5. The method of claim 1, wherein the coverage value of the wireless transceiver is changed in such a manner that a coverage region of the wireless transceiver does not overlap with a coverage region of another wireless transceiver.

6. The method of claim 1, further comprising generating a coverage value of the wireless transceiver based on the received information about the wireless transceiver, when a previously stored coverage value of the wireless transceiver is not present.

7. The method of claim 1, further comprising changing a signal strength of the wireless transceiver based on a changed coverage value.

8. The method of claim 1, further comprising transmitting information about the wireless transceiver having a changed coverage value to an external device.

9. The method of claim 1, wherein the wireless transceiver is an access point.

10. An apparatus for controlling coverage of a wireless transceiver, the apparatus comprising:
a communication unit that receives information about the wireless transceiver from an external device; and
a control unit that changes a coverage value of the wireless transceiver based on the received information about the wireless transceiver.

11. The apparatus of claim 10, wherein the information about the wireless transceiver comprises unique information of the wireless transceiver and signal strength information about the wireless transceiver, which signal strength information is detected by the external device.

12. The apparatus of claim 11, wherein the information about the wireless transceiver further comprises location information about the external device.

13. The apparatus of claim 12, wherein the location information about the external device is Global Positioning System (GPS) information about the external device.

14. The apparatus of claim 10, wherein the control unit changes the coverage value such that a coverage region of the wireless transceiver does not overlap with a coverage region of another wireless transceiver.

15. The apparatus of claim 10, wherein the control unit generates a coverage value of the wireless transceiver based on the received information about the wireless transceiver, when a previously stored coverage value of the wireless transceiver is not present.

16. The apparatus of claim 10, wherein the control unit controls a signal strength of the wireless transceiver based on a changed coverage value.

17. The apparatus of claim 10, wherein the communication unit transmits information about the wireless transceiver having a changed coverage value to an external device.

18. The apparatus of claim 10, wherein the wireless transceiver is an access point.

19. A non-transitory computer readable recording medium having recorded thereon a program for executing a method of controlling coverage of a wireless transceiver, the method comprising:
receiving information about the wireless transceiver from an external device; and
changing a preset coverage value of the wireless transceiver based on the received information about the wireless transceiver.
